(19) United States
(12) Patent Application Publication
(10) Pub. No.: US 2006/0129616 A1
(43) Pub. Date: Jun. 15, 2006

(54) SYSTEM AND METHOD FOR SYNCHRONIZING COMPUTER FILES BETWEEN A LOCAL COMPUTER AND A REMOTE SERVER

(76) Inventor: Mien-Chih Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/163,400

(22) Filed: Oct. 18, 2005

(30) Foreign Application Priority Data
Dec. 10, 2004 (TW) 093138252

(51) Int. Cl. G06F 17/30

(52) U.S. Cl. 707/204

(57) ABSTRACT

A system for synchronizing files between a local computer (1) and a remote server (3) is provided. The local computer includes: a path designating module (10) for designating a path of a source directory in the local computer and a path of an object directory in the remote server; a file list generating module (12) for generating a file list recording an organization of all sub-directories and files under the source directory; and a transmitting module (14) for transmitting the file list and files to be updated to the remote server. The remote server includes: a receiving module (30) for receiving the file list and the files to be updated; a comparing module (32) for comparing the organization recorded in the file list with an organization of the object directory; and a file synchronizing module (34) for synchronizing files in the object directory.

### FIELD OF THE INVENTION

The present invention is generally related to systems and methods for synchronizing computer files, and, more particularly, is related to a system and method for synchronizing computer files between two computers.

### DESCRIPTION OF RELATED ART

The changing or “updating” or “synchronizing” of computer files is a normal process in computer science. Computer files are routinely updated as technology advances and improvements are developed. Application files are also frequently updated to eliminate bugs that are found during usage. Data files are typically modified as new data are acquired, or old data are determined to be invalid. Files comprising text are also routinely modified for numerous reasons well known in the art.

Traditionally, changes in files have been implemented by creating a completely NEW file containing all desired changes, and distributing this full, modified file to all users to be downloaded to replace the existing file.

File “patching” techniques have been used in the prior art to revise existing files. The administration of these techniques is complex, and installation of the patch is often as involved technically and economically as the installation of a fully revised version of the file.

Recent patents in the art include a U.S. Pat. No. 6,526,574 entitled “System for finding differences between two computer files and updating the computer files” and issued on Feb. 25, 2003. The patent discloses a system for finding the difference between an existing computer file and an updated version of the file using a fixed amount of memory, and using these differences to implement the desired update of the existing file. The system can easily build a patch, and easily install the patch, and can work with a single file, with a group of files, with directories, and with directory trees.

However, the patent only updates differences of the existing files, and there is still room for improving when working with a large amount of files and with multi-layer directory trees.

Therefore, what is needed is a system and method for synchronizing computer files between computers more efficiently when working with a large amount of files and with multi-layer directory trees.

### SUMMARY OF INVENTION

Embodiments of the present invention provide a system and method for synchronizing computer files between a local computer and a remote server.

Briefly described, one embodiment of such a system can be implemented as described herein. The system includes modules in the local computer: a path designating module for designating a path of a source directory in the local computer and a path of an object directory in the remote server; a file list generating module for generating a file list recording an organization of all sub-directories and files under the source directory according to a directory tree of the source directory; and a transmitting module for transmitting the file list and files to be updated to the remote server. The system further includes modules in the remote server: a receiving module for receiving the file list and the files to be updated from the local computer; a comparing module for comparing the organization recorded in the file list with an organization of the object directory; and a file synchronizing module for synchronizing files in the object directory according to the comparison results generated by the comparing module.

One embodiment of such a method can be broadly summarized by the steps described hereinafter. The method includes the steps of: designating a path of a source directory in the local computer and a path of an object directory in the remote server respectively; setting the source directory as a current directory; generating a file list recording an organization and attributes of sub-directories and files in the first layer under the current directory, according to a directory tree of the current directory; transmitting the file list to the remote server; synchronizing files in the object directory according to the file list; determining whether any sub-directory in the first layer under the current directory has not been synchronized; judging whether the current directory is switched to the source directory if all the sub-directories in the first layer under the current directory have been synchronized; and switching the current directory to its parent directory and returning to the determining step until the current directory is switched to the source directory.

Other systems, methods, features, and advantages of the present invention will be or become apparent to one with skill in the art upon examination of the following drawings and detailed description.

### BRIEF DESCRIPTION OF DRAWINGS

FIG. 1 is a schematic diagram illustrating hardware configuration of a system for synchronizing computer files between a local computer and a remote server, in accordance with one embodiment of the present invention;

FIG. 2 is a schematic diagram illustrating function modules of the local computer of FIG. 1;

FIG. 3 is a schematic diagram illustrating function modules of the remote server of FIG. 1; and

FIG. 4 is a flowchart illustrating a method for synchronizing computer files between a local computer and a remote server, in accordance with one embodiment of the present invention.

### DETAILED DESCRIPTION

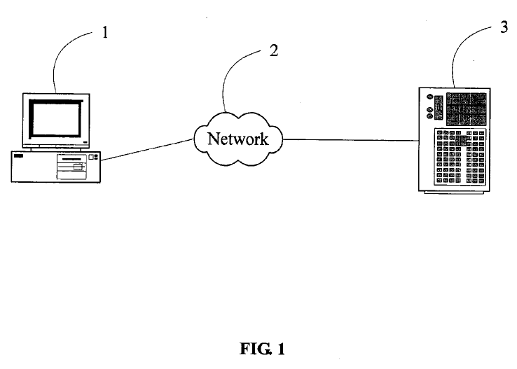

FIG. 1 is a schematic diagram illustrating hardware configuration of a system for synchronizing computer files between a local computer and a remote server, in accordance with one embodiment of the present invention. The system includes a local computer 1, a remote server 3, and a network 2.

The local computer 1 can be a personal computer (PC), which may include a plurality of hardware devices, such as a central processing unit (CPU), a memory, a hard-disk, a monitor, a mouse and a key board. The local computer 1 may also be installed with some software, such as an operating system (OS) and application software. By using these hardware and software resources, the local computer 1 further provides a graphic user interface for a user to operate the local computer 1.

The remoter server 3 may also be a personal computer like the local computer 1, or may be a network server computer, which can process data with a faster computing speed than a PC.

The network 2 connects the local computer 1 with the remote server 3, which may be an electronic network based on a Transfer Control Protocol and Internet Protocol (TCP/IP), such as a Local Area Network (LAN) or the Internet. The local computer 1 synchronizes files and directories of an object directory in the remote server 3 to accord with a source directory in the local computer 1 through the network 2.

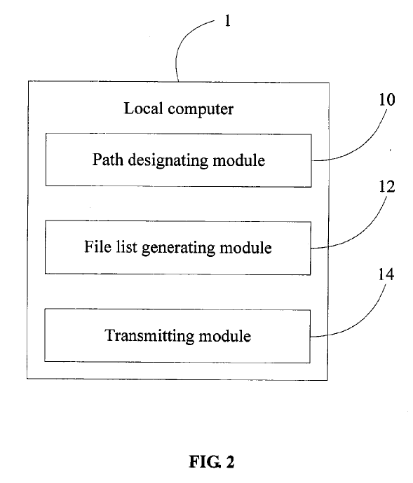

FIG. 2 is a schematic diagram illustrating function modules of the local computer 1. The local computer 1 typically includes a path designating module 10, a file list generating module 12, and a transmitting module 14.

The path designating module 10 is used for designating a path of a source directory in the local computer 1 and a path of an object directory in the remote server 3. For example, the source directory in the local computer 1 is designated as “D:/resources/20041129,” and the object directory in the remote server 3 is designated as “/10.129.82.23/update.” Files and sub-directories under the object directory can be updated to accord with corresponding files and sub-directories under the source directory.

The file list generating module 12 is used for generating a file list recording an organization of all sub-directories and files under the source directory according to a directory tree of the source directory. The file list generating module 12 retrieves attributes and the organization of the sub-directories and files under the source directory from the OS installed in the local computer 1, to create a data structure for storing the attributes and the organization. The organization of the sub-directories and files under the source directory records relationships between the sub-directories and files according to the directory tree of the source directory. Attributes of a sub-directory or a file may include a name, a size, a last modification time and modification authorizations of the sub-directory or the file. The file list is kept in the memory of the local computer 1 until the synchronization process is completed.

The transmitting module 14 is used for transmitting the file list and files to be updated to the remote server 3 through the network 2. If any file recorded in the file list is not in the object directory, or any file in the object directory has different attributes when compared with a counterpart in the file list, the file is to be updated in the object directory according to the file list.

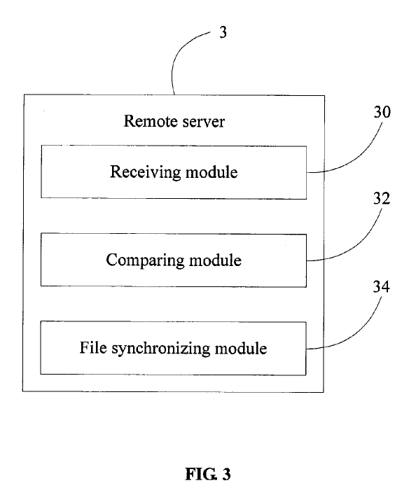

FIG. 3 is a schematic diagram illustrating function modules of the remote server 3. The remote server 3 typically includes a receiving module 30, a comparing module 32, and a file synchronizing module 34.

The receiving module 30 is used for receiving the file list and the files to be updated transmitted from the local computer 1. The file list and the files are then stored in a memory of the remote server 3.

The comparing module 32 is used for comparing the file list with the object directory. The comparing module 32 retrieves the file list from the memory of the remote server 3, compares the organization recorded in the file list with an organization of the object directory, and compares attributes of the files and sub-directories recorded in the file list with the counterparts in the object directory.

The file synchronizing module 34 is used for synchronizing files in the object directory according to comparison results generated by the comparing module 32. Synchronizing files may include deleting sub-directories and files in the object directory which are not recorded in the file list, and/or updating files in the object directory which have different attributes when compared with their respective counterparts in the file list. Updating files in the object directory may include: copying the files to the object directory from the source directory, if the files recorded in the file list are not in the object directory; replacing the files in the object directory with corresponding files in the source directory, if the files in the object directory have different attributes when compared with their respective counterparts in the file list.

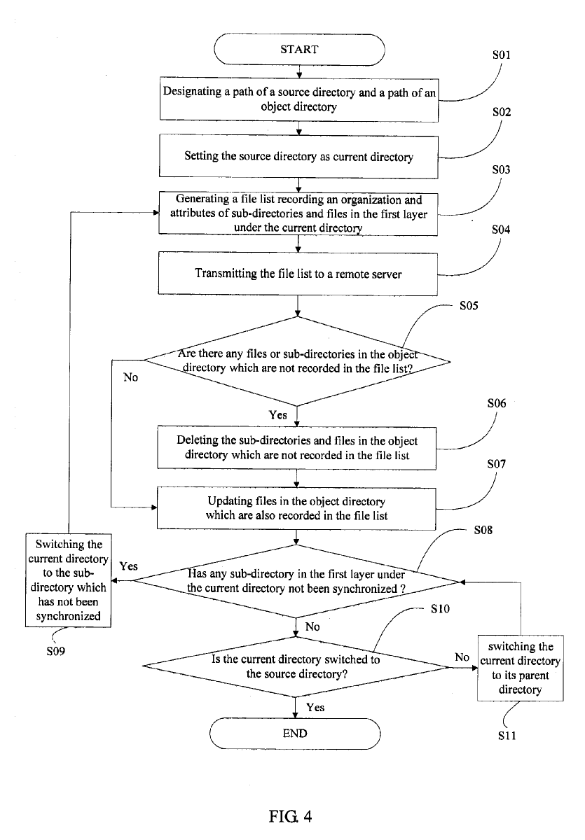

FIG. 4 is a flowchart illustrating a method for synchronizing computer files between the local computer 1 and the remote server 3, in accordance with one embodiment of the present invention. In step S01, the path designating module 10 designates a path of a source directory and a path of an object directory respectively. In step S02, the file list generating module 12 sets the source directory as a current directory. In step S03, the file list generating module 12 generates a file list recording an organization and attributes of sub-directories and files in the first layer under the current directory, according to a directory tree of the current directory. In step S04, the transmitting module 14 transmits the file list to the remote server 3. In step S05, the receiving module 30 retrieves the file list, and the comparing module 32 compares the organization and attributes recorded in the file list with the counterparts of the object directory, in order to determine whether there are files or sub-directories in the object directory which are not recorded in the file list. If all files and sub-directories in the object directory are also recorded in the file list, the procedure goes directly to step S07. Otherwise, if there are files or sub-directories in the object directory which are not recorded in the file list, in step S06, the file synchronizing module 34 deletes such sub-directories and files in the object directory. In step S07, the file synchronizing module 34 updates the files in the object directory which are also recorded in the file list. The above three steps of S05, S06, and S07 may be considered as a general step of synchronizing files in the current directory according to the file list. In step S08, the comparing module 32 determines whether any sub-directory in the first layer under the current directory has not been synchronized. If there is a sub-directory in the first layer under the current directory which has not been synchronized, in step S09, the current directory is switched to the sub-directory which has not been synchronized, and then the procedure returns to step S03 described above. If all the sub-directories in the first layer under the current directory have been synchronized, in step S10, the comparing module 32 determines whether the current directory is switched to the source directory. If the current directory is switched to the source directory, the procedure ends here. Otherwise, if the current directory is not switched to the source directory, in step S11, the current directory is switched to its parent directory, and then the procedure returns to step S08 described above.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for synchronizing computer files between a local computer and a remote server, the local computer comprising:
a path designating module for designating a path of a source directory in the local computer and a path of an object directory in the remote server;
a file list generating module for generating a file list recording an organization of all sub-directories and files under the source directory according to a directory tree of the source directory; and
a transmitting module for transmitting the file list and files to be updated to the remote server; and
the remote server comprising:
a receiving module for receiving the file list and the files to be updated from the local computer;
a comparing module for comparing the organization recorded in the file list with an organization of the object directory; and
a file synchronizing module for synchronizing files in the object directory according to the comparison results generated by the comparing module.

2. The system according to claim 1, wherein the file list further records attributes of sub-directories and files under the source directory.

3. The system according to claim 2, wherein attributes of each sub-directory or each file comprises a name, a size, a last modification time and modification authorizations of the sub-directory or the file.

4. A method for synchronizing computer files between a local computer and a remote server, the method comprising the steps of:
designating a path of a source directory in the local computer and a path of an object directory in the remote server respectively;
setting the source directory as a current directory;
generating a file list recording an organization and attributes of sub-directories and files in the first layer under the current directory, according to a directory tree of the current directory;
transmitting the file list to the remote server;
synchronizing files in the object directory according to the file list;
determining whether any sub-directory in the first layer under the current directory has not been synchronized;
judging whether the current directory is switched to the source directory if all the sub-directories in the first layer under the current directory have been synchronized; and
switching the current directory to its parent directory and returning to the determining step until the current directory is switched to the source directory.

5. The method according to claim 4, further comprising the step of: switching the current directory to a sub-directory and returning to the generating step if the sub-directory in the first layer under the current directory has not been synchronized.

6. The method according to claim 4, wherein the synchronizing step comprises the steps of:
comparing the organization and attributes recorded in the file list with an organization and attributes of the object directory;
deleting sub-directories and files in the object directory which are not recorded in the file list; and
updating files in the object directory which have different attributes when compared with their respective counterparts in the file list.

7. The method according to claim 4, wherein attributes of each sub-directory or each file comprises a name, a size, a last modification time and modification authorizations of the sub-directory or the file.
